(19) United States
(12) Patent Application Publication
(10) Pub. No.: US 2014/0169663 A1
(43) Pub. Date: Jun. 19, 2014

(54) System and Method for Video Detection and Tracking

(71) Applicant: FUTUREWEI TECHNOLOGIES, INC., Plano, TX (US)

(72) Inventors: Xu Han, Columbia, MO (US); Dong-Qing Zhang, Plainsboro, NJ (US); Hong Heather Yu, West Windsor, NJ (US)

(73) Assignee: FutureWei Technologies, Inc., Plano, TX (US)

(21) Appl. No.: 13/720,653

(22) Filed: Dec. 19, 2012

(51) Int. Cl. G06K 9/00

(52) U.S. Cl. CPC G06K 9/00369
USPC 382/159; 382/170; 382/165

(57) ABSTRACT

System and method embodiments are provided to enable features and functionalities for automatically detecting and localizing the position of an object in a video frame and tracking the moving object in the video over time. One method includes detecting a plurality of objects in a video frame using a combined Histograms of Oriented Gradients (HOG) and Local Binary Pattern (LBP) algorithm, highlighting the detected objects, and tracking one of the detected objects that is selected by a user in a plurality of subsequent video frames. Also included is a user device configured to detect a plurality of objects in a video frame displayed on a display screen coupled to the user device using a combined HOG and LBP algorithm, highlight the detected objects, and track one of the detected objects that is selected by a user in a plurality of subsequent video frames on the display screen.

### TECHNICAL FIELD

The present invention relates to a system and method for video processing, and, in particular embodiments, to a system and method for player highlighting in sports video.

### BACKGROUND

Sports video broadcasting and production is a notable business for many cable, broadcasting, or entertainment companies. For example, ESPN has a sports video production division. Some sports video production divisions have proprietary software to perform advanced editing functionalities to sports videos. The features of the software include adding virtual objects (e.g., lines) into the video or video frames. It is also expected that more sports video production features and functionalities could appear in future video production software. One building block feature of such software is to detect and track moving objects in sports video, such as players on a sports field, which could be applied in many scenarios in sports video editing applications. One example of such scenarios is to avoid player occlusion when inserting virtual objects into the videos. Improving and adding production features and functionalities in video production software is desired for improving sports or other video broadcasting and online streaming businesses, improving viewer quality of experience, and attracting more customers.

### SUMMARY

In one embodiment, a method for video detection and tracking includes detecting a plurality of objects in a video frame using a combined Histograms of Oriented Gradients (HOG) and Local Binary Pattern (LBP) algorithm, highlighting the detected objects, and tracking one of the detected objects that is selected by a user in a plurality of subsequent video frames.

In another embodiment, a user device for video detection and tracking includes a processor and a computer readable storage medium storing programming for execution by the processor, the programming including instructions to detect a plurality of objects in a video frame displayed on a display screen coupled to the user device using a combined HOG and LBP algorithm, highlight the detected objects on the display screen, and track one of the detected objects that is selected by a user in a plurality of subsequent video frames on the display screen.

In yet another embodiment, an apparatus for video detection and tracking includes a detection module configured to detect a plurality of objects in a frame in a video using a combined HOG and LBP algorithm, a tracking module configured to track one of the detected objects that is selected by a user in a plurality of subsequent frames in the video, and a graphic interface including a display configured to highlight the detected objects in the frame and the tracked object in the subsequent frames.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an embodiment system for video detection and tracking.

FIG. 2 illustrates an embodiment of a graphic interface for video detection and tracking.

FIG. 3 illustrates an embodiment method for video detection and tracking.

FIG. 4 illustrates an example of labeled images to train a video player detector.

FIG. 5 illustrates an embodiment method for a HOG-LBP detection algorithm.

FIG. 6 shows a comparison between the performance of a HOG-LBP detection algorithm and a deformable model algorithm.

FIG. 7 shows an example of a video player in tracking mode.

FIG. 8 shows an example of a video player in verification mode.

FIG. 9 is a block diagram of a processing system that can be used to implement various embodiments.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

System and method embodiments are disclosed herein to enable features or functionalities for video detection and tracking. The features automatically detect and localize the position of an object (e.g., a sports player) in a video frame and track the moving object in the video over time, e.g., in real time. The functionalities provide improved accuracy in detecting and tracking moving objects in video in comparison to current or previous algorithms or schemes. The functionalities include detecting and highlighting one or more objects (e.g., players) in a video (e.g., a sports video). A user can select a detected and highlighted object that is of interest to the user. The object (e.g., player) may be highlighted with a bounding box (or scanning window) in each frame when the video is playing. The selected and highlighted object is then tracked in subsequent video frames, e.g., until the detection process is restarted.

A combination of Histograms of Oriented Gradients (HOG) and Local Binary Pattern (LBP) algorithms is used to describe every scanning window in a sliding window detection approach. The HOG algorithm is described by N. Dalal and B. Triggs in “Histograms of oriented gradients for human detection,” in conference for Computer Vision and Pattern Recognition (CVPR) 2005, volume 1, pages 886-893, 2005, which is incorporated herein by reference. The HOG features (or descriptors) are based on edge orientation histograms, scale-invariant feature transform (SIFT) features or descriptors, and shape contexts, and are computed on a dense grid of uniformly spaced cells and use overlapping local contrast normalizations for improved performance. The LBP algorithm is described by T. Ojala, et al. in “A comparative study of texture measures with classification based on feature distributions,” in Pattern Recognition, 29(1):51-59, 1998, which is incorporated herein by reference. The SIFT algorithm is described by D. G. Lowe in “Distinctive image features from scale-invariant keypoints,” in International Journal of Computer Vision, vol. 60, no. 2, pp. 91-110, 2004, which is incorporated herein by reference.

Features of LBP are also described by T. Ahonen, et al. in “Face Recognition with Local Binary Patterns,” in the Eighth European Conference for Computer Vision, pp. 469-481, 2004, and in “Face Description with Local Binary Patterns: Application to Face Recognition,” in IEEE Transactions on Pattern Analysis and Machine Intelligence, 28(12): 2037-2041, 2006, both of which are incorporated herein by reference. The combined features of the locally normalized HOG and the LBP improve the performance of detecting moving objects in a video, as described below. A combined HOG and LBP scheme is described by Xiaoyu Wang, et al. in “An HOG-LBP Human Detector with Partial Occlusion Handling,” in International Conference on Computer Vision (ICCV) 2009, which is incorporated herein by reference.

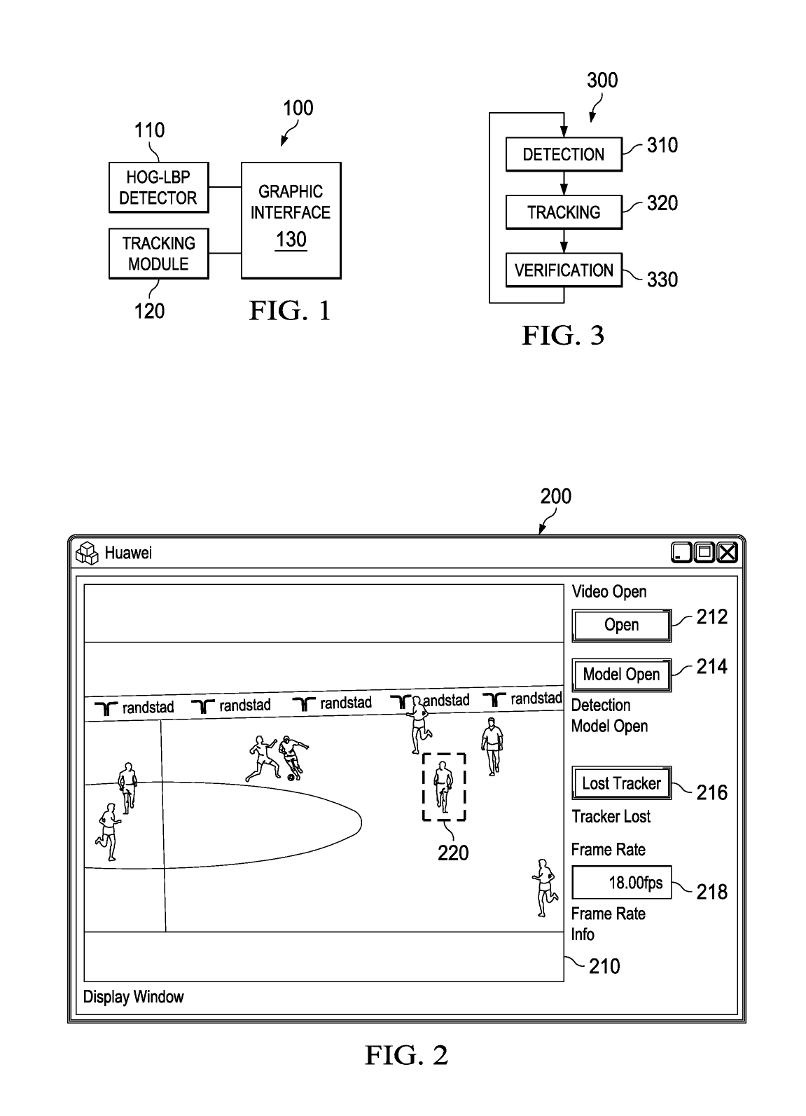

FIG. 1 illustrates an embodiment system 100 for video detection and tracking. For example, the system 100 may be part of or added to a video player software and/or hardware system. The system 100 includes a video player detector 110 that is trained with a combined HOG and LBP algorithm for detecting objects in a video frame. The training can be implemented using a Support Vector Machine (SVM) on manually labeled data from sports videos with the National Institute for Research in Computer Science and Control (INRIA) dataset. The trained HOG-LBP detector 110 is then used to automatically highlight (for a user or viewer) one or more objects (e.g., players) in a video frame. The system 100 also includes a tracking module 120 configured to track a detected player that is selected by the user, e.g., across multiple video frames.

The system 100 also includes a user friendly graphic interface 130, for instance using Microsoft Foundation Class (MFC). The graphic interface 130 is coupled to the detector 110 and the tracking module 120, and is configured to display video frames and enable the functions by the detector 110 and the tracking module 120. For instance, the tracking module 120 can track a moving object, such as a player, displayed via the graphic interface 130 at a determined average rate, e.g., 15 frames per second (fps) with sufficiently stable and precise result. The player is initially detected by the detector 110 and selected by the user via the interface 130. The system 100 may be developed and implemented for different software platforms, for instance as a Windows™ version or a Linux version. The system 100 may correspond to or may be part of a user equipment (UE) at the customer location, such as a video receiver, a set top box, a desktop/laptop computer, a computer tablet, a smartphone, or other suitable devices. The system 100 can be used for detection and tracking of any still or moving video objects in any type of played video, e.g., real-time played or streamed video or saved and loaded video (such as from a hard disk or DVD).

FIG. 2 illustrates an embodiment of a Windows™ based graphic interface 200 that may be part of the system 100 (i.e., that corresponds to the interface 130). The interface 200 comprises a display window 210 for displaying video (playing video frames). The interface 200 comprises a plurality of buttons, including an open button 212 for opening a video for display, a model option button 214 for opening a list of detection modes (e.g. based on different algorithms), a lost tracker button 216 for handling a situation of losing track on a moving object (i.e., a player) as described below. The interface 200 also includes a frame rate field 218 for entering the desired frame rate for displaying the video frames in the display window 210. FIG. 1 also shows a player 220 labeled or highlighted by the system's detector (e.g., the HOG-LBP detector 110) and selected by a user or viewer. The highlighted player 220 can be selected by the user (e.g., from a plurality of detected players in the frame) and is indicated by a box or window around the player 220. Other suitable formats and shapes can be used to label or highlight the player 220. Similar interfaces to the interface 200 can also be implemented for different software or operating system (OS) platforms, such as Linux.

FIG. 3 illustrates an embodiment method 300 for video detection and tracking that can be implemented by the system 100. At step 310, the system 100 loads a video (e.g., sports video) and runs a detection process (e.g., using the detector 110), for instance in the first frame of the input video. Every detected object (e.g., player) is then labeled or highlighted, for example with bounding boxes or windows. The user can select a player of interest, for instance by clicking the bounding box of interest. At step 320, the selected player is tracked (e.g., using the tracking module 120). The tracked player is visualized to the user (e.g., on the display window 210), for instance using a colored bounding box. At step 330, a verification process is implemented to check whether the track on the player is lost or whether the tracked player is no longer tracked properly. The verification process may also be implemented by the tracking module 120. If the track on the player is lost, the bounding box may not be located properly around the player. If the tracking module 120 loses the track on the player, the method 300 returns to step 310, where the detection process is applied on the current frame to detect each object (or player). The method 300 then proceeds to step 320 to reinitialize the tracking process. The user can also stop the track on a player and return to step 310 to select another detected player for tracking. The method 300 can be used to assist a video content analyst to annotate video more efficiently. The method 300 can be used for detection and tracking of any still or moving video objects in any type of played video, e.g., real-time played or streamed video or saved and loaded video (such as from a hard disk or DVD).

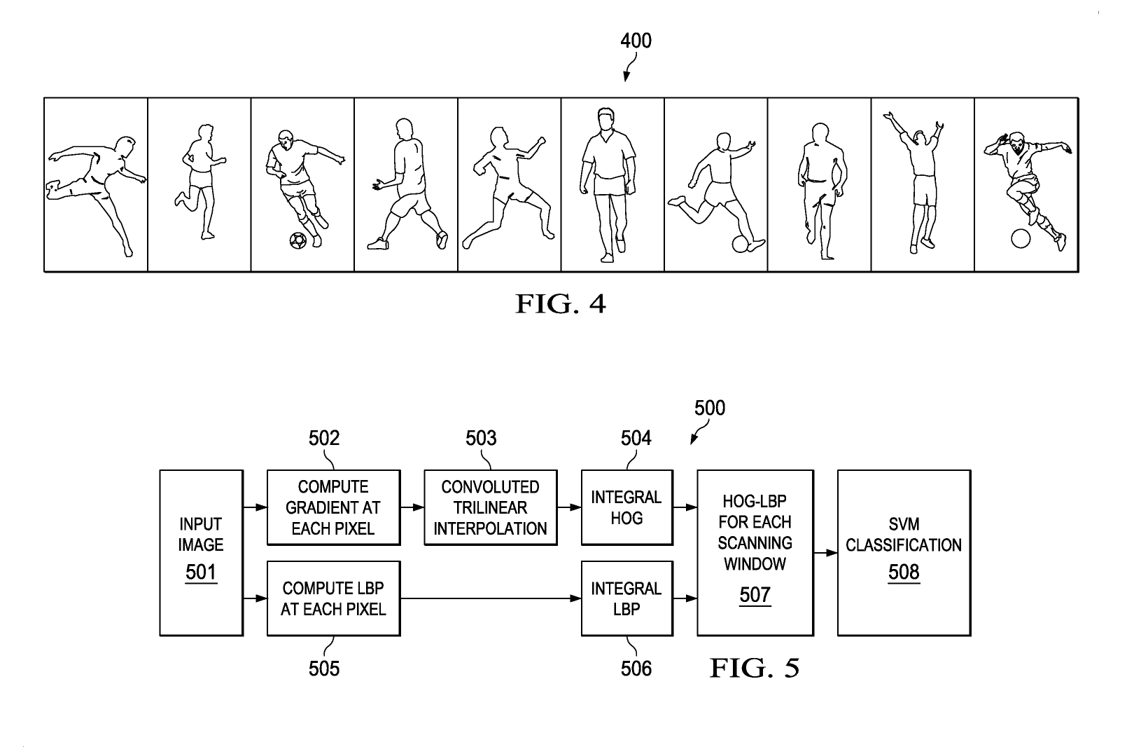

FIG. 4 illustrates an example of sample labeled images 400 that can be used to train the video detector, e.g., the HOG-LBP detector 110. In a training phase of the HOG-LBP detector, the HOG and LBP feature is extracted on a manually labeled soccer player dataset and the INRIA dataset. The soccer player dataset is labeled from 10 video clips which comprises more than 1,000 frames. More than 5,000 positive (i.e., used) examples of players are manually labeled from the video, while more than 890,000 negative (i.e., not used) examples are randomly cropped from background area. After combining the two datasets into one, a final dataset is obtained with about 9 Gigabytes (GB) of data. A sample of the positive training images is shown in FIG. 4. A SVM code is used on this dataset to train a half body model to detect soccer players. The SVM code spent more than 3 hours to process the data.

FIG. 5 illustrates an embodiment method 500 for a HOG-LBP algorithm detection. The method 500 can be implemented by a detector, e.g., the HOG-LBP detector 110, in a detection phase (after the training phase). In the detection phase, the HOG and LBP features (i.e., descriptors) are extracted from all the scanning windows in each frame. The HOG and LBP features are concatenated and sent for classification using the SVM model learned in the training phase. Detection results are post-processed by a mean shift algorithm to refine the results. To accelerate the speed of the detector, an integral histogram technique is used to simplify the feature extraction step. The integral histogram technique is described by Xiaoyu Wang, et al. in “An HOG-LBP Human Detector with Partial Occlusion Handling,” in ICCV 2009, which is incorporated herein by reference. Similar to the integral image technique described by P. Viola and M. Jones in “Robust real-time face detection,” in the International Journal of Computer Vision, vol. 57, no. 2, pp. 137-154, May 2004, which is incorporated herein by reference, the integral histogram technique can simplify the feature extraction to two vector addition and two vector subtraction.

The detection algorithm includes the steps of the method 500. At step 501, an input image (or video frame) is received. At steps 502, the gradient at each pixel in the image is computed, in accordance with the HOG algorithm. At step 503, the gradients at the pixels are processed using convoluted tri-linear interpolation. At step 504, the output of step 503 is processed using integral HOG. At step 505, the LBP at each pixel in the image is also computed, in accordance with the LBP algorithm. At step 506, the output of step 505 is processed using integral LBP. The steps 502, 503, 504 and the steps 505 and 506 can be implemented in parallel. The outputs form steps 504 and 506 are processed using a combined HOG and LBP algorithm (to compute a HOG-LBP feature) for each scanning window. At step 508, the output of step 507 is processed using SVM classification.

A deformable model algorithm described by P. Felzenszwalb, et al. in “A discriminatively trained, multiscale, deformable part model,” in CVPR, 2008, which is incorporated herein by reference, has achieved efficient detection algorithms on various standard datasets including the INRIA dataset shown by Dalal and B. Triggs, the PASCAL dataset shown by Everingham, et al. in “The PASCAL Visual Object Classes Challenge,” at http://www.pascal-network.org/challenges/VOC/voc2011/workshop/index.html, the TUD dataset shown by M. Andriluka, et al. in “People-Tracking-by-Detection and People-Detection-by-Tracking,” in CVPR 2008, and the Caltech pedestrian dataset shown by P. Dollar, et al. in “Pedestrian Detection: A Benchmark,” in CVPR 09, Miami, USA, June 2009, all of which are incorporated herein by reference.

The HOG-LBP algorithm described above is able to handle the deformable part and to localize the object tightly in comparison to the deformable model algorithms. To compare the HOG-LBP algorithm to the deformable model algorithm, the deformable model algorithm is set up using the HOG-LBP features, taking two root filters and several part filters. The performance of such configured deformable algorithm is acceptable. However, the algorithm's speed may be relatively slow. Thus, the deformable algorithm is not suitable for directly processing sport videos, which may require faster implementation. The deformable model algorithm is applied on test images to compare the performance with the HOG-LBP detection algorithm described above.

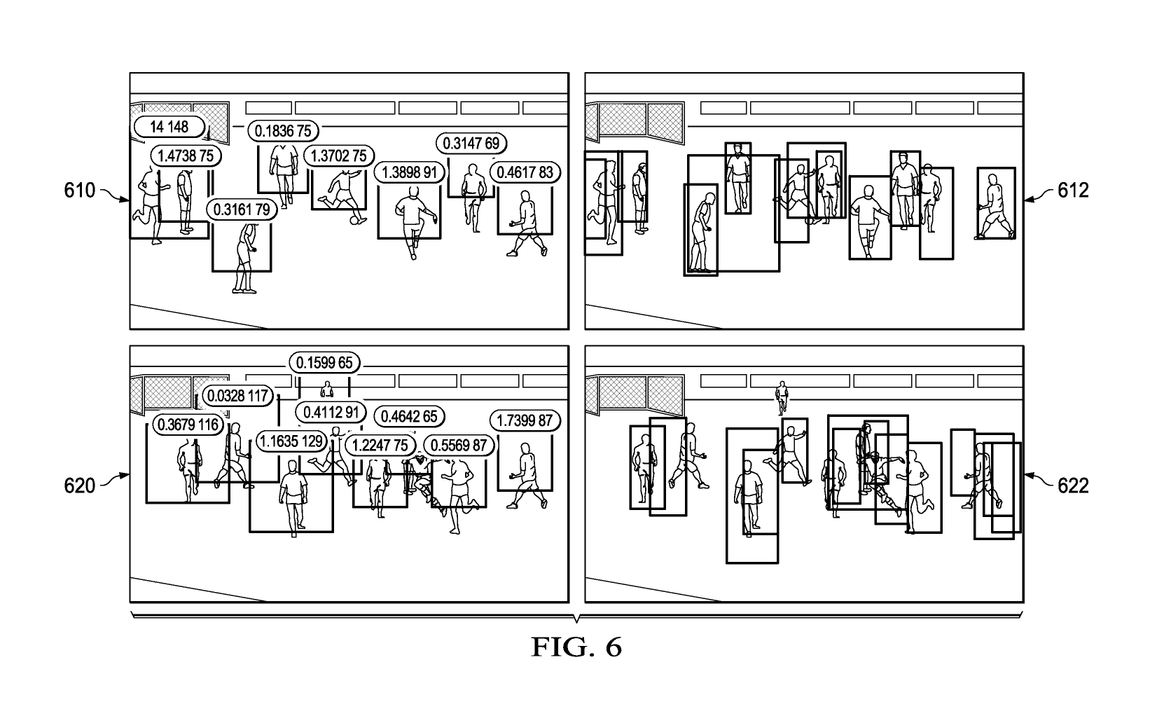

FIG. 6 shows a comparison between the performance of the HOG-LBP detection algorithm and the deformable model algorithm. The players in frames 610 and 620 are detected using the HOG-LBP detection algorithm. The detected players are highlighted by the boxes or windows around the players. Frames 612 and 622 are associated with the same images of frames 610 and 620, respectively. However, the players in frames 612 and 622 are detected using the deformable model algorithm and also highlighted by corresponding boxes. Initially, the HOG-LBP detection algorithm provided satisfying results comparable to the deformable model algorithm. The frames above show the results of the HOG-LBP algorithm after tuning parameters of this algorithm. Comparing the different frames shows that the results of the HOG-LBP algorithm after tuning are better than the results of the deformable model algorithm, e.g., each of the players is detected and highlighted by a corresponding box with fewer overlaps between the players and the boxes. Additionally, the HOG-LBP algorithm takes substantially less time for detection, which makes it applicable for video detection purpose (unlike the deformable model algorithm).

To guarantee that the detection algorithm matches the speed requirement of real time video playing, the tracking module can be integrated with the video detection software. For processing speed consideration, a practical and relatively simple approach is implemented by computing the similarity of candidate window patches (scanning windows or boxes) with the highlighted object's patch. Given the position of a player in a last frame, the patch is cropped out and the HOG-LBP feature is computed. A color histogram is also computed for this patch using hue channel of a HSV color model. By combining HOG-LBP and color histogram, the feature is built to describe the object patch. In the current frame, a sliding window method is applied on the neighboring area of the object's last position. The HOG-LBP and color histogram features are extracted for every scanning window to compare with the object feature. The similarity measure of two patches is evaluated by computing the correlation of two feature vectors, which is an inner product of two features. The candidate window with the maximum score is selected and compared with a pre-determined threshold. The threshold is set to check whether the patch is similar enough with the last one. If the candidate window is higher than the threshold, the candidate window is accepted as the new location of the object and the object tracking continues. Otherwise, a verification module is invoked to correct the result or stop tracking to restart detection.

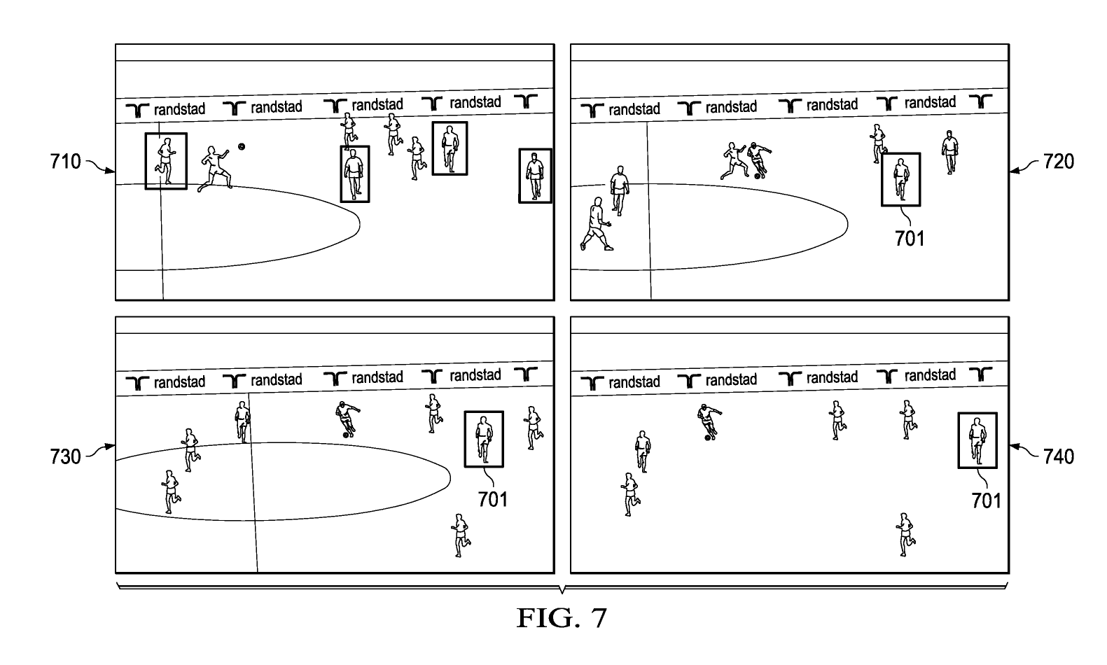

The tracking is used in addition to the detection to improve the performance of the system. While detection is implemented initially to identify the objects, the tracking function is used in subsequent frames to improve the speed of the system. Tracking a moving object in subsequent frames is simpler and faster to implement (in software) than applying the detection of objects for each frame. FIG. 7 shows an example of a video player in tracking mode. A plurality of video frames 710, 720, 730, and 740 are shown for a sports event (a soccer game). In frame 710, multiple players are detected and highlighted using the detection algorithm described above. A subsequent frame 720 shows one highlighted player 701 that is selected by the user and thus tracked (by the tracking module). In frame 730, the same tracked player 701 is still highlighted as the player 701 moves and changes location with respect to the frame (and the playing field). In frame 740, the tracked and highlighted player 701 moves to the edge of the frame. When the player is at or beyond the frame's edge, the tracking module may lose the tracking on the player. This may trigger the detector to restart and detect objects (players) in the current frame.

As described above, the advantage of tracking in comparison to detection in each frame is speed. However, the bounding box for tracking an object (or player) of interest may drift over time (e.g., after a number of frames), for instance due to variations in the object (or player) appearance, background clutter, illumination change, occlusion, and/or other changes or aspects in the frames. To handle the drift effect of tracking and correct the position of the box or window patch, a verification process is included to the detection and tracking processes. After the tracking process extracts the HOG-LBP and color histogram in the neighboring area of the last tracked position, a next step is implemented to verify if there exists one window in the neighboring area that includes a player or object within. The HOG-LBP feature is sent to SVM processing to find candidate locations of the player. The the color histogram of the candidates is then compared with one or more previous tracking results. The score for verification is based on the weighted sum of SVM and color histogram comparison results. The candidate patch with the maximum score is compared with a pre-determined verification threshold. If the score is greater than the threshold, the tracking continues.

However, if the score is below the threshold, the following steps are implemented. If the verification function is invoked for a first time (during tracking), a counter is initialized for the number of verification attempts, and the verification function is called in the next frame. The tracking module or function is applied on the current frame to provide a prediction for next verification. If the system can't correct the position of the player after implementing the verification process on a plurality of subsequent frames, then the system resets the counter and ends the tracking. The system can then return to the detection process.

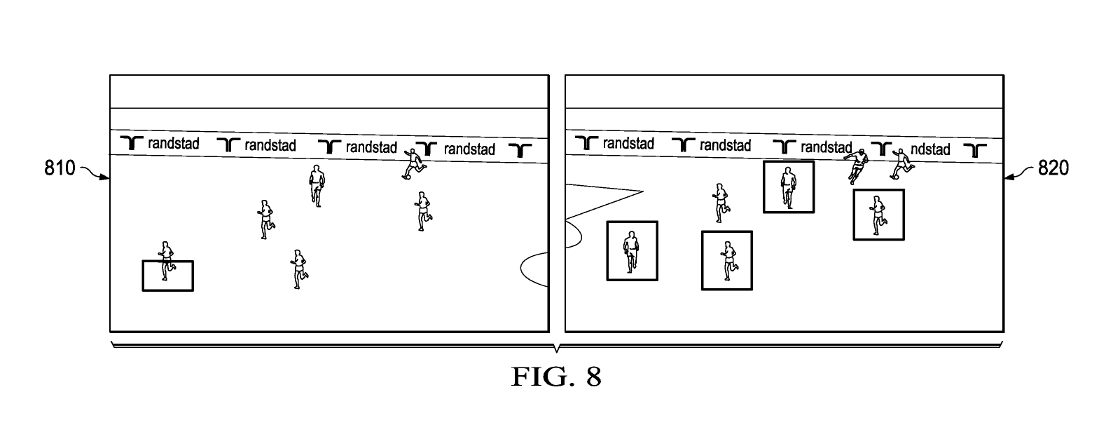

FIG. 8 shows an example of a video player in verification mode. Two video frames 810 and 820 are shown for a sports event (a soccer game). In frame 810, the patch drifts away from the tracked player (where the box does not capture the player properly). The drift in the patch may progress through multiple frames until the patch loses track on the player. If the verification process (during tracking) is not able to correct the tracking in a number of subsequent frames, for example after a pre-determined number of verification attempts, the tracker is stopped and the detector is initiated to highlight a plurality of players in a current frame, as shown in frame 820. The user can then reselect the previously tracked player or a new player for tracking.

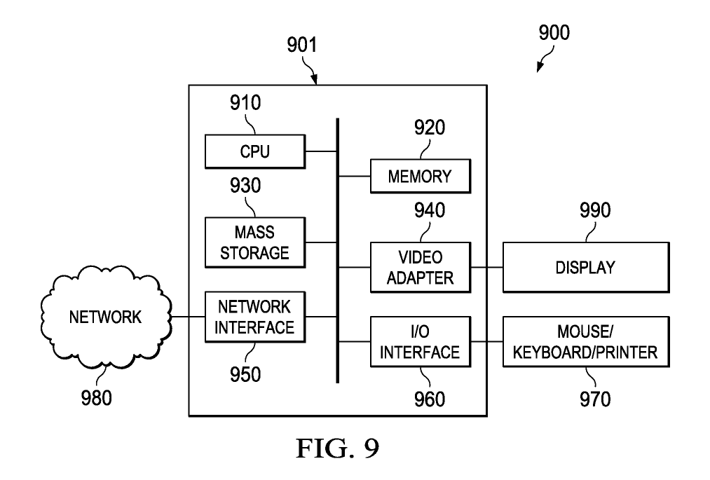

FIG. 9 is a block diagram of a processing system 900 that can be used to implement various embodiments. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 900 may comprise a processing unit 901 equipped with one or more input/output devices, such as a speaker, microphone, mouse, touchscreen, keypad, keyboard, printer, display, and the like. The processing unit 901 may include a central processing unit (CPU) 910, a memory 920, a mass storage device 930, a video adapter 940, and an I/O interface 960 connected to a bus. The bus may be one or more of any type of several bus architectures including a memory bus or memory controller, a peripheral bus, a video bus, or the like.

The CPU 910 may comprise any type of electronic data processor. The memory 920 may comprise any type of system memory such as static random access memory (SRAM), dynamic random access memory (DRAM), synchronous DRAM (SDRAM), read-only memory (ROM), a combination thereof, or the like. In an embodiment, the memory 920 may include ROM for use at boot-up, and DRAM for program and data storage for use while executing programs. In embodiments, the memory 920 is non-transitory. The mass storage device 930 may comprise any type of storage device configured to store data, programs, and other information and to make the data, programs, and other information accessible via the bus. The mass storage device 930 may comprise, for example, one or more of a solid state drive, hard disk drive, a magnetic disk drive, an optical disk drive, or the like.

The video adapter 940 and the I/O interface 960 provide interfaces to couple external input and output devices to the processing unit. As illustrated, examples of input and output devices include a display 990 coupled to the video adapter 940 and any combination of mouse/keyboard/printer 970 coupled to the I/O interface 960. Other devices may be coupled to the processing unit 901, and additional or fewer interface cards may be utilized. For example, a serial interface card (not shown) may be used to provide a serial interface for a printer.

The processing unit 901 also includes one or more network interfaces 950, which may comprise wired links, such as an Ethernet cable or the like, and/or wireless links to access nodes or one or more networks 980. The network interface 950 allows the processing unit 901 to communicate with remote units via the networks 980. For example, the network interface 950 may provide wireless communication via one or more transmitters/transmit antennas and one or more receivers/receive antennas. In an embodiment, the processing unit 901 is coupled to a local-area network or a wide-area network for data processing and communications with remote devices, such as other processing units, the Internet, remote storage facilities, or the like.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for video detection and tracking, the method comprising:
detecting a plurality of objects in a video frame using a combined Histograms of Oriented Gradients (HOG) and Local Binary Pattern (LBP) algorithm;
highlighting the detected objects; and
tracking one of the detected objects that is selected by a user in a plurality of subsequent video frames.

2. The method of claim 1 further comprising:
training the combined HOB and LBP algorithm by extracting HOG and LBP features on a manually labeled soccer player dataset and a National Institute for Research in Computer Science and Control (INRIA) dataset;
combining the manually labeled soccer player dataset and the INRIA data sat to obtain a combined dataset; and
learning a Support Vector Machine (SVM) algorithm on the combined dataset for a half body model to detect moving video objects.

3. The method of claim 1, wherein detecting the objects in the video frame using the combined HOG and LBP algorithm comprises:
extracting HOG and LBP features from a plurality of scanning windows in the video frame;
concatenating the HOG and LBP features;
classifying the concatenated HOG and LBP features using a Support Vector Machine (SVM) model learned in a training phase; and
refining classification results using a mean shift algorithm.

4. The method of claim 1, wherein detecting the objects in the video frame using the combined HOG and LBP algorithm comprises:
computing a gradient at each pixel in the video frame;
calculating a convoluted tri-linear interpolation for the gradient of each pixel;
computing an integral HOG;
computing a LBP at each pixel;
computing an integral LBP;
calculating a HOG-LBP feature for each scanning window; and
using a Support Vector Machine (SVM) classification for each scanning window.

5. The method of claim 1, wherein tracking one of the detected objects comprises:
evaluating similarity of candidate window patches with a window patch of the tracked object by computing a correlation of corresponding feature vectors;
selecting a candidate window with a maximum correlation;
comparing the selected candidate window with a threshold; and
accept the candidate window as a new location of the tracked object if the correlation of the candidate window is higher than the threshold or invoking a verification process to correct tracking or restart detection if the correlation of the window is not higher than the threshold.

6. The method of claim 1 further comprising:
verifying whether the tracked object is tracked properly in the subsequent frames; and
stopping tracking if the selected object is not tracked properly.

7. The method of claim 6 further comprising restarting detection of a plurality of new objects in a last subsequent frame if tracking is stopped.

8. The method of claim 6, wherein the object is not tracked properly if a window for tracking the tracked object is not positioned substantially around the tracked object or drifts away from the tracked object in the subsequent frames beyond a pre-determined threshold.

9. The method of claim 6, wherein verifying the tracked object is tracked properly comprises:
verifying if there exists one window in a neighboring area of the tracked object that includes an object within;
using HOG-LBP features of the object and Support Vector Machine (SVM) processing to find candidate patches of the object;
comparing a color histogram of each of the candidate patches with one or more previous tracking results based on a weighted sum of SVM and color histogram score;
selecting a candidate patch with a maximum score
comparing the maximum score of the selected candidate patch to a pre-determined verification threshold; and
continue tracking if the maximum score is greater than the pre-determined verification threshold.

10. The method of claim 9 further comprising if the maximum score is not greater than the pre-determined verification threshold:
initializing a counter for verification attempts if verifying the tracked object is invoked for a first time during tracking;
verifying the tracked object in a next video frame; and
resetting the counter and ending tracking if the counter for verification attempts reaches a pre-determined limit for a pre-determined number of subsequent frames.

11. The method of claim 1 further comprising highlighting the selected and tracked object but not the remaining detected objects in the subsequent frames.

12. A user device for video detection and tracking, the user device comprising:
a processor; and
a computer readable storage medium storing programming for execution by the processor, the programming including instructions to:
detect a plurality of objects in a video frame displayed on a display screen coupled to the user device using a combined Histograms of Oriented Gradients (HOG) and Local Binary Pattern (LBP) algorithm;
highlight the detected objects on the display screen; and
track one of the detected objects that is selected by a user in a plurality of subsequent video frames on the display screen.

13. The user device of claim 12, wherein the programming includes further instructions to highlight the selected and tracked object by displaying a bounding box around the selected and tracked object in each of the subsequent frames on the display screen.

14. The user device of claim 12, wherein highlighting the detected objects comprises placing a bounding box around each of the detected objects in the video frame.

15. The user device of claim 12, wherein the video frames correspond to a real-time sports event, and wherein the objects are players.

16. An apparatus for video detection and tracking, the apparatus comprising:
a detection module configured to detect a plurality of objects in a frame in a video using a combined Histograms of Oriented Gradients (HOG) and Local Binary Pattern (LBP) algorithm;
a tracking module configured to track one of the detected objects that is selected by a user in a plurality of subsequent frames in the video; and
a graphic interface including a display configured to highlight the detected objects in the frame and the tracked object in the subsequent frames.

17. The apparatus of claim 16, wherein the tracking module is further configured to:
verify whether the tracked object is tracked properly in the subsequent frames; and
stop tracking if tracking is lost or substantially drifting away from the selected object.

18. The apparatus of claim 16, wherein tracking an object in a subsequent frame by the tracking module is substantially faster than detecting the object in the subsequent frame by the detection module.

19. The apparatus of claim 16, wherein the graphic interface further includes an open button to select a video to open for detection and tracking, a model button for selecting an algorithm for detecting the objects, a lost tracker button for ending tracking and restarting detection, and a frame rate field for entering a target frame rate in frames per second.

20. The apparatus of claim 16, wherein the tracking module is configured to track the selected object in the subsequent frames while the video is playing in real-time.
